(19) United States
(12) Patent Application Publication
(10) Pub. No.: US 2008/0179120 A1
(43) Pub. Date: Jul. 31, 2008

(54) Motorized electric wheel

(76) Inventor: Stanley F. Stafford, Fort Worth, TX (US)

Correspondence Address: LYNN E BARBER, P O BOX 16528, FORT WORTH, TX, 76162, US

(21) Appl. No.: 11/700,333

(22) Filed: Jan. 31, 2007

(51) Int. Cl. B60K 1/00

(52) U.S. Cl. 180/65.2

(57) ABSTRACT

A motorized electric wheel for a vehicle including a circular armature having a central hole and comprising a coil wheel having electro-magnetic coils; a shaft inserted through the hole and being fixed to the circular armature and to the vehicle so that the shaft does not rotate; a pair of bearings fixed to the shaft, one bearing on each side of the armature; a cover rotatably surrounding the armature and resting on the bearings; and two wires connected to a switching mechanism, each of the wires connected to the electro-magnetic coils. The motorized electric wheel of the invention may be used for any type of motorized vehicle.

### BACKGROUND OF THE INVENTION

1. Field of the Invention

This invention relates to electric vehicles, and in particular, relates to vehicles in which the power train group is replaced with a motorized electric wheel.

2. Description of the Related Art

Vehicles traditionally have a drive train/power train, which refers to the group of components that generate power and deliver it to the road surface. This may simply be the engine and transmission or more typically this group includes the engine or motor, transmission, drive shafts, differentials and the final drive (drive wheels) which are connected together electrically so that energy from the gasoline and/or battery may be used to turn the wheels of the vehicle.

Electric motors or generators typically comprise an armature and a field winding or field magnets. The field component creates a magnetic field with which the armature may interact. Current is carried by the armature, which is oriented normal to the field and the direction of motion. Because the armature carries current crossing the field, it creates shaft torque in a rotating machine. In standard prior motors, the armature moves, and in fact, another term for a prior armature is a circular rotor because the body of the armature rotates. Wire coils on the armature, when periodically energized, act as electromagnets. Sequential pulsed energizing of the coils causes ferric material to be urged in one direction or another by magnetic attraction. Electromotive force is created by the relative motion of the armature and field, which opposes the armature current, and the armature converts electrical power to mechanical torque and power and transfers it to the load (e.g., the vehicle and its wheels) via the drive shaft.

While most vehicles are powered by gasoline or other fuels, it is of great environmental interest to provide vehicles that are powered completely, or at least in part, by battery power, thus doing away with the high cost of liquid fuel. Unfortunately, because most vehicles require the physical components that comprise the drive train, which occupy a large space, it is difficult or impossible to have a large enough space in normally-sized vehicles that have drive trains so that there can be a battery of sufficient size to power the vehicle. In addition, the drive train components together are heavy, requiring more energy to move a vehicle containing them. Even in hybrid vehicles utilizing both batteries and gasoline, there is not sufficient space to allow for sufficient battery power so that the vehicle can be maximally energy efficient.

It is therefore an object of the invention to provide a way of eliminating most of the traditional drive train in vehicles so that there is sufficient space in the vehicles for batteries. It is a further object of the invention to provide a motorized electric wheel that may be used in a wide variety of vehicles, including but not limited to motor cycles, automobiles and trucks, and trains, particularly in conjunction with battery power.

Other objects and advantages will be more fully apparent from the following disclosure and appended claims.

### SUMMARY OF THE INVENTION

The invention herein is a motorized electric wheel for a vehicle including a circular armature having a central hole and comprising a coil wheel having electro-magnetic coils; a shaft inserted through the hole and being fixed to the circular armature and to the vehicle so that the shaft does not rotate; a pair of bearings fixed to the shaft, one bearing on each side of the armature; a cover rotatably surrounding the armature and resting on the bearings; and two wires connected from a switching mechanism, each of the wires connected to the electro-magnetic coils. The motorized electric wheel of the invention may be used for any type of motorized vehicle.

Other objects and features of the inventions will be more fully apparent from the following disclosure and appended claims.

### BRIEF DESCRIPTION OF THE DRAWINGS

FIG. 1 is a plan view of an armature that may be used in the motorized electric wheel of the invention herein having a single coil circle.

FIG. 2 is a plan view of an armature that may be used in the motorized electric wheel of the invention having two coil circles.

FIG. 3 is an exploded image side view of the motorized electric wheel of the invention.

FIG. 4 is a perspective view of the assembled motorized electric wheel of the invention.

### DETAILED DESCRIPTION OF THE INVENTION AND PREFERRED EMBODIMENTS THEREOF

The present invention provides a motorized electric wheel that makes possible totally electric vehicles, such as electric cars, by providing sufficient space for batteries to power the vehicles.

The motorized electric wheel for a vehicle of the invention comprises a circular armature having a central hole and comprising a coil wheel having two electro-magnetic coils; a shaft inserted through the hole and being fixed to the circular armature and to the vehicle so that the shaft does not rotate; a pair of bearings fixed to the shaft, one bearing on each side of the armature; a cover rotatably surrounding the armature and resting on the bearings; and two wires connected from a switching mechanism, the wires being connected to the electro-magnetic coils. The motorized electric wheel of the invention may be used for any type of motorized vehicle such as motorized two-wheel or four-wheel vehicles, automobiles and trains.

Referring in greater detail to the figures, the motorized electric wheel 10 of the invention herein comprises an armature 12, which may be similar to a standard armature in a typical motor, except that in the invention herein, the armature does not move/rotate, and the field produced by the electrical components moves with respect to the armature.

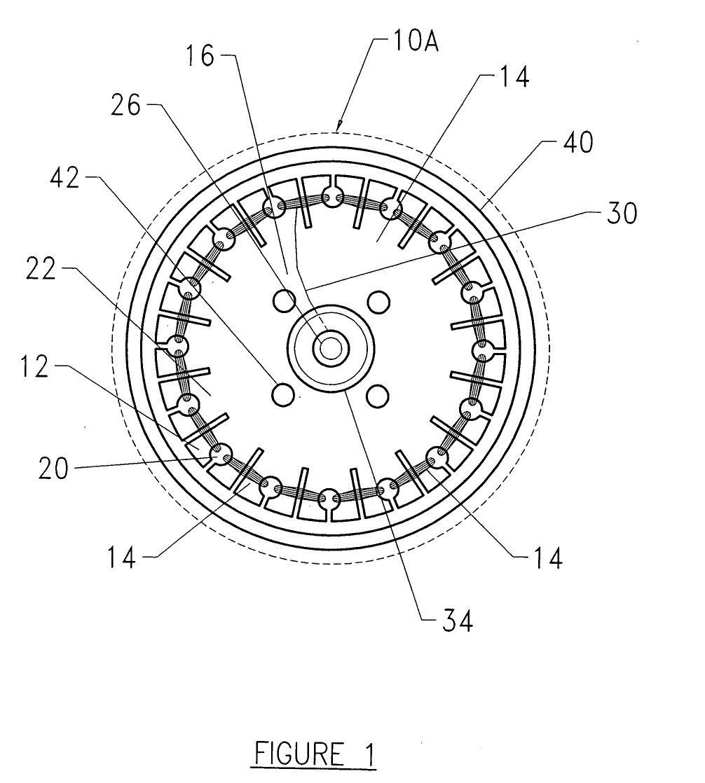

In a preferred embodiment of the invention shown in the figures, which is sized for use with motorcycles, the motor armature 12 comprises coil wiring wraps 14 of copper wire as shown in FIG. 1. The body 16 of the preferred armature used in the invention thus may be a circular disk made of laminated steel and having a diameter so that the armature 12 fits within the inside diameter of the rim of the wheel 18. Clearly, the size of this circle, as well as the other components discussed herein, could be adjusted as appropriate for different sized wheels by one of ordinary skill in the art. Thus, between the invention and the rim may be interposed spokes or other features known in the art of wheel rim construction.

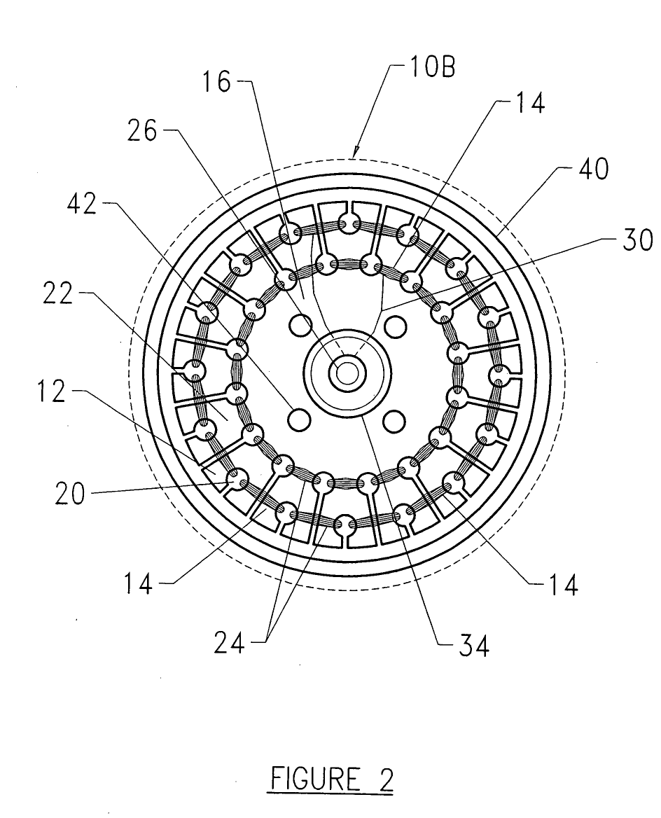

The body (coil wheel) 16 of the armature 12 comprises laminated plates of steel and has a series of slots 20 in one or more consecutive circles on the body for winding the armature coil, with electrical conductor (copper) wire being wound around teeth 22 between adjacent slots 29 in each concentric circle, as is known in the art to form an electro-magnetic coil. Thus, as shown in FIG. 1, preferably there is one circle of copper wire windings 24. Alternatively, there may be two consecutive circles/coils of copper wire windings forming two electro-magnetic coils 24 as shown in FIG. 2, with the number of coils and the number of wire turns around the teeth for each winding, as well as other armature components being variable as known in the art of armature construction. Thus, the number of coil wiring wraps and windings forming each of the electro-magnetic coils would depend on the power, voltage and magnetic field for the size of motorized electric wheel 10 that is being manufactured.

Standard switching mechanisms are used with the invention to enable switching as known in the art to enable the wheel to go forward or backward.

Through a central hole 26 in the armature 12, a hollow core wiring shaft 28 extends, inside which is standard electrical wiring 30 to energize the electro-magnet to make the wheel go forward or backward. The electrical wiring 30 extends from the switching mechanism 32 to the electro-magnetic coil(s) 24 of the armature 12. As used herein, the term “conductively attached” means that turning the switch on to cause current to go through the electrical wiring causes the current to go to the attached electro-magnetic coil, which results in energizing that electro-magnetic coil. The wires exit the shaft 28 through a hole 46.

The wiring shaft 28 is in turn fixed to the frame of the vehicle (not shown) in a manner dependent on the type and structure of the vehicle. The body (coil wheel) 16 of the armature 12 is fixed to the shaft 28, preferably by press-fitting.

Also mounted on the shaft 28, one on each side of the coil wheel, are two tire or rim bearings 34 (preferably identical inner and outer bearings) that are fixed to the shaft 28, preferably by shrink-fitting as known in the art.

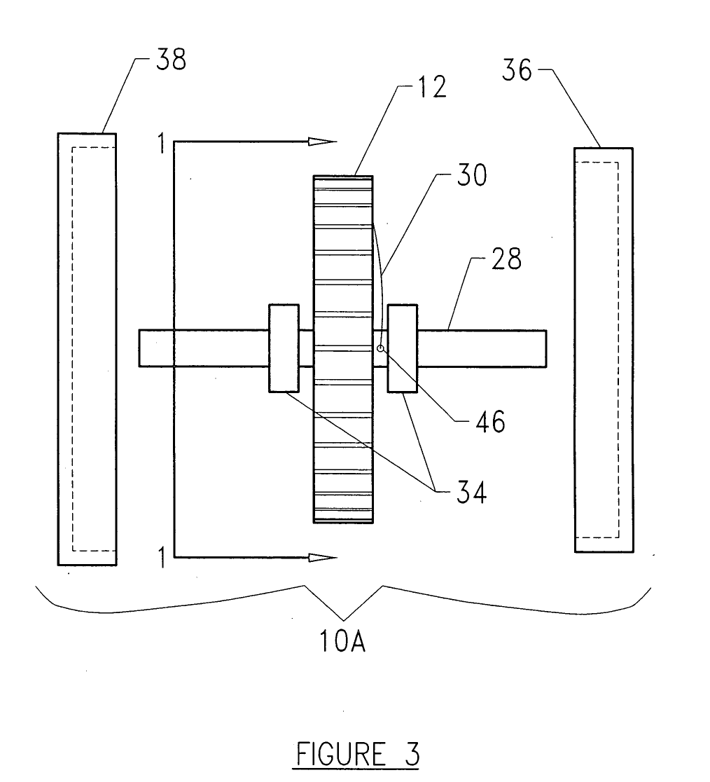

The armature 12 is surrounded by two cover portions 36,38, which are fixed together, the joined cover portions forming a cover over the armature. Inner and outer cover portions 36,38 are mounted on the bearings 34 (FIG. 3). The bearings 34 allow the cover portions 36,38 to rest when no power is needed or being provided with the vehicle wheel resting on the bearings. The inner and outer cover portions 36,38 serve as a bearing cage for the inner and outer bearings respectively. The bearings 34 are standard bearings that allow the outside wheel 18 to turn around the armature 12 which is on the inside of the cover 40 mounted to the shaft 28. The cover 40 thus rotates freely around the armature 12 that is fixed to the bearings and shaft. Thus, the cover 40 is essentially a metal dish surrounding the armature, which also serves as a dust cover over the armature. The cover 40 may also be made of other materials, such as strong plastic, so long as the functional characteristics of the invention are not adversely affected.

As is known in the art of making wheels, the body (coil wheel) 16 preferably has a number of holes 42 surrounding the central hole 26, such as the four holes 42 shown in FIG. 1, to allow the assembled wheel to be easily balanced. Also, not having a solid body wheel reduces the amount of steel needed.

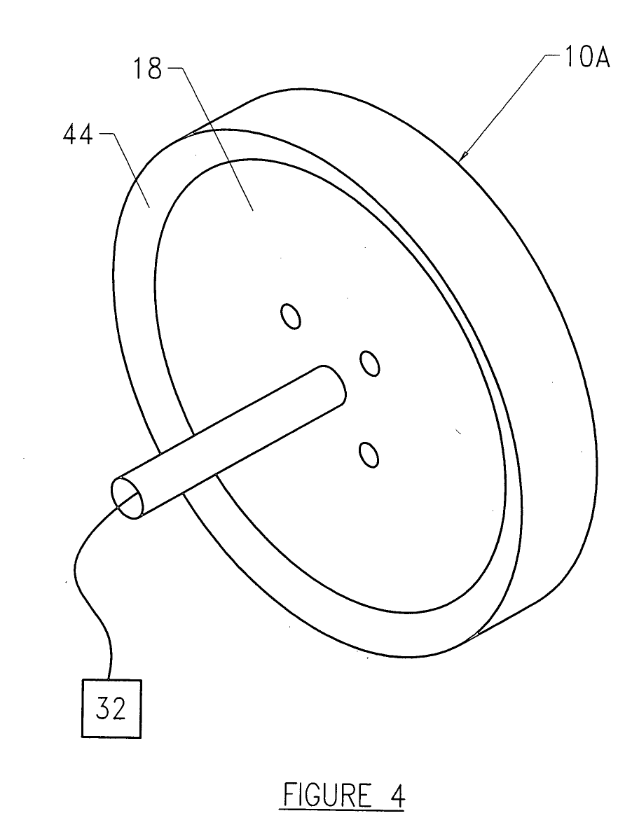

In a vehicle utilizing the invention, each motorized electric wheel is constructed to include the invention (FIG. 4), and includes a tire 44 and a switching mechanism 32 connected to each wheel for control of the wheels, so that each wheel is appropriately powered, preferably by standard means of electrically signaling the armature coil(s).

The invention herein may be used in any powered vehicle having wheels, including but not limited to motorcycles, automobiles (cars, trucks and the like), and trains. Vehicles requiring more power would utilize different coil configurations and designs as are known in the art.

While in the preferred embodiment, the invention is used with battery-powered vehicles, the invention may also be used with hybrid vehicles.

While the invention has been described with reference to specific embodiments, it will be appreciated that numerous variations, modifications, and embodiments are possible, and accordingly, all such variations, modifications, and embodiments are to be regarded as being within the spirit and scope of the invention.

What is claimed is:

1. A motorized electric wheel for a vehicle, comprising:
a) a circular armature having a central hole and comprising an electro-magnetic coil wheel;
b) a shaft inserted through the central hole and being fixed to the circular armature and to the vehicle so that the shaft does not rotate;
c) a pair of bearings fixed to the shaft, one bearing on each side of the armature;
d) a cover rotatably surrounding the armature and resting on the bearings; and
e) wiring connecting the magnetic coil wheel to a switching mechanism.

2. The motorized electric wheel of claim 1, wherein the cover comprises an inner cover portion and an outer cover portion attached together around the armature.

3. The motorized electric wheel of claim 1, wherein the vehicle is selected from the group consisting of motorized wheeled vehicles, automobiles and trains.
